(19) United States
(12) Patent Application Publication
(10) Pub. No.: US 2005/0208927 A1
(43) Pub. Date: Sep. 22, 2005

(54) Automated sending of preconfigured messages

(76) Inventors: Marcel Wong, Lund (SE); Magnus Svensson, Malmo (SE)

Correspondence Address: MYERS BIGEL SIBLEY & SAJOVEC, PO BOX 37428, RALEIGH, NC, 27627, US

(21) Appl. No.: 10/519,278

(22) PCT Filed: May 14, 2003
(86) PCT No.: PCT/EP03/05027

§ 371 Date: Dec. 22, 2004

(30) Foreign Application Priority Data
Jun. 28, 2002 (EP) 020144291
Jul. 3, 2002 (EP) 60393906

(51) Int. Cl. H04Q 7/20

(52) U.S. Cl. 455/412.1; 455/466

(57) ABSTRACT

A control unit retrieves date information from an electronic data determination unit and first recipient related information related to a recipient from an electronic contact register. The control unit then effectuates essentially automatic sending of a pre-configured electronic message to the recipient based on the date information and the first recipient related information.

### TECHNICAL FIELD OF THE INVENTION

The present invention relates to the field of computer communication and telecommunication. More particularly the present invention relates to a method of sending messages over networks, an electronic device for sending such messages as well as a computer readable medium including program code for performing said method and a computer program element including such code.

### DESCRIPTION OF RELATED ART

It is known within the field of computers and wireless communication to send different types of messages, like e-mail and SMS (Short Message Service). In cases of e-mail it is also known to attach different types of files to an e-mail, where these files can be video-files, text files, audio files or image files. Recently there has been a development of a new type of messages in wireless communications. These messages are called MMS (Multimedia Messaging Service). In these MMS messages it is possible to include such things as photos, sound files or video files. The files that can be included can also be presented directly to a recipient without having being opened by him or her, i.e. they are not attachments.

It is also known to provide a calendar and clock where the date is set both In computers and cellular phones.

It is furthermore known to store information about contacts in a special area. This information often Includes information about position, phone number, e-mail address and can also include information about birthdays and anniversaries. In the case of computer systems this information is usually available In connection with the software for sending e-mails, like for instance in Microsoft's Outlook-system. Here there is also normally provided a Calendar.

In the world of cellular phones the contact information is normally provided in connection with PIM (Personal Information Management) software, where phone book, calendar, electronic notes as well as a section with information about contacts is present. A PIM nowadays also has a vCard section, where contact information in the form of electronic business cards can be sent and received.

There thus exist a number of tools for sending messages, but there is a need for being able to send special messages automatically, which is not present in the systems of today.

### SUMMARY OF THE INVENTION

The present invention is directed towards solving the problem of sending specialised messages to certain selected recipients, without the user having to do anything more than possibly accepting the sending of a specialised message.

According to a first aspect of the present invention this problem is solved by a method of automatically sending special electronic messages to a selected recipient including the steps of: retrieving date information from an electronic date determination unit, retrieving first recipient related information from an electronic contact register, and automatically sending a special pre-configured electronic message over a network to the recipient in dependence of the date information and the first recipient related information.

According to a second aspect of the present invention, this problem is also solved by an electronic equipment for automatically sending special electronic messages to a selected recipient comprising: an electronic date determination unit, an electronic contact register, a message transfer unit, a pre-configured message store and a control unit. The control unit is arranged to retrieve date information from the electronic data determination unit and first recipient related information relating to a recipient from the electronic contact register and effectuate automatic sending of a special pre-configured electronic message to the recipient in dependence of the date information and the first recipient related information.

According to a third aspect of the present invention, this problem is furthermore solved by a program product comprising a computer readable medium, having thereon: computer program code means, to make a computer or an electronic equipment execute, when said program is loaded in the computer or the electronic equipment, retrieving of date information from an electronic date determination unit, retrieving of recipient related information from an electronic contact register, and effectuating automatic sending of a special pre-configured electronic message over a network to the recipient in dependence of the date information and the recipient related information.

According to a fourth aspect of the present invention this problem is furthermore solved by a computer program element comprising: computer program code means to make a computer or an electronic equipment execute retrieving of date information from an electronic date determination unit, retrieving of recipient related information from an electronic contact register, and effectuating automatic sending of a special pre-configured electronic message over a network to the recipient in dependence of the date information and the recipient related information.

The present invention is furthermore directed towards solving the problem of letting a user make a finer selection of which recipient to send a specialised message to. According to a fifth aspect of the present invention this problem is solved by a method, which includes the steps of the first aspect and furthermore the step of retrieving second recipient related information from the electronic contact register and sending the message also in dependence of the second recipient related information.

According to a sixth aspect of the present invention this problem is also solved by an electronic device, which includes the features of the second aspect and where the control unit is further arranged to retrieve second recipient related information from the electronic contact register and effectuate sending of the message also in dependence of the second recipient related information.

A seventh aspect of the present invention includes the features of the first aspect, wherein the first recipient related information is date information associated with the recipient.

An eighth aspect of the present invention includes the features of the first aspect, wherein the first recipient related information is a special message flag.

A ninth aspect of the present invention includes the features of the fifth aspect, wherein the second recipient related information is a special message flag.

A tenth aspect of the present Invention includes the steps of the first aspect and further the steps of prompting a user, after retrieving date and recipient related information, about sending the message and sending the message if the user has accepted sending.

An eleventh aspect of the present invention includes the steps of the first aspect and further the step of retrieving the name of the recipient from the contact register and inserting the name into the message prior to sending.

A twelfth aspect of the present invention includes the steps of the first aspect and furthermore directly sending the message to a terminal of the recipient.

A thirteenth aspect of the present invention includes the steps of the first aspect and furthermore sending of the message to a remote server, which pushes it to a terminal of the recipient it.

A fourteenth aspect of the present invention includes the steps of the first aspect and furthermore the step of receiving contact information about a recipient from a remote server and then placing it in the contact register.

A fifteenth aspect of the present invention includes the features of the first aspect, wherein the contact register is a register based on previously stored information about contacts and how these can be reached.

A sixteenth aspect of the present invention includes the features of the first aspect, wherein the method is provided in a portable communication device.

A seventeenth aspect of the present Invention includes the features of the second aspect, wherein the first recipient related information is date information associated with the recipient.

An eighteenth aspect of the present invention includes the features of the second aspect, wherein the first recipient related information is a special message flag.

A nineteenth aspect of the present invention includes the features of the sixth aspect, wherein the second recipient related information is a special message flag.

A twentieth aspect of the present invention includes the features of the second aspect and where the control unit after retrieving date and recipient related information is further arranged to prompt a user about sending the message and effectuate sending of the message if the user has accepted sending.

A twenty-first aspect of the present invention includes the features of the second aspect and where the control unit is further arranged to retrieve the name of the recipient from the contact register and to insert the name into the message prior to sending.

A twenty-second aspect of the present invention includes the features of the second aspect and where the control unit further effectuates sending of the message directly to a terminal of the recipient.

A twenty-third aspect of the present invention includes the features of the second aspect and where the control unit further effectuates sending of the message to a remote server, which pushes it to the recipient.

A twenty-fourth aspect of the present invention includes the features of the second aspect and where the message transfer unit receives contact information about a recipient from a remote server and the control unit is further arranged to place this information in the contact register.

A twenty-fifth aspect of the present invention includes the features of the second aspect and where the device is a portable communication device.

A twenty-sixth aspect of the present invention includes the features of the twenty-fifth aspect and where the device is a cellular phone.

A twenty-seventh aspect of the present invention includes the features of the second aspect, wherein the contact register is a register based on previously stored information about contacts and how these can be reached.

In one special case of the preferred embodiment according to the present invention, the first mentioned problem is solved by automatically sending a birthday greeting to a recipient based on the information in a contact section in a phone or computer.

The invention has the following advantages. The user can automatically send specialised greetings like Christmas cards and birthday greetings without having to actually write the greeting. This can avoid embarrassing moments for users that have bad memories or are too busy to send greetings, but still wish to send greetings. This invention thus avoids disappointing people a user cherishes and have close. Because of the automatic way in which specialised messages are sent, the sending also goes fast and simple and with little effort input by the user.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 shows an electronic device in the form of a cellular phone,

FIG. 2 shows the phone in FIG. 1 connected to a server via a cellular network,

FIG. 3 shows a block schematic of a messaging unit and PIM unit together with a system clock in the interior of the phone in FIG. 1,

FIG. 4 shows a block schematic of different parts of the messaging unit and the PIM unit together with the system clock in FIG. 2,

FIG. 5 shows a flow chart of a method of performing the method according to a preferred embodiment of the invention,

FIG. 6 shows a flow chart of a method of performing the method according to an alternative embodiment of the invention, and

FIG. 7 shows a CD Rom on which program code for executing the method according to the invention is provided.

### DETAILED DESCRIPTION OF EMBODIMENTS

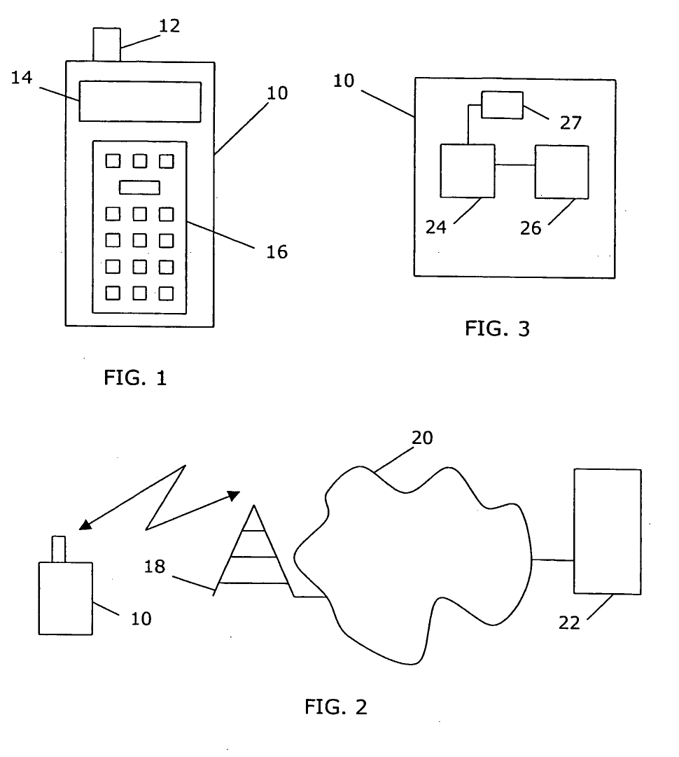

An electronic equipment or device 10 according to the invention is shown in FIG. 1. In the preferred embodiment the device is a cellular phone 10 having an antenna 12, a display 14 and a keypad 16 including a number of keys. The keypad 16 is used for entering information such as selection of functions and responding to prompts and the display 14 is used for displaying functions and prompts to a user of the phone. The antenna 12 is used for communication with other users via a network. A cellular phone is just one example of a device in which the invention can be implemented. The invention can for instance also be used in a PDA (personal digital assistant), a palm top computer, a lap top computer and even on a regular computer such as a PC (personal computer), as long as the device has access to some kind of network over which messages can be sent.

FIG. 2 shows the cellular phone 10 connected to a cellular network 20 via a base station 18 for communication with a server 22 also connected to the network 20. The network is normally a GSM-type of network or a GPRS network. It is of course also possible that the network is WCDMA network. The server 22 is a server supplying chat possibilities to the phone, like for instance in the form of wireless village. The server 22 can be directly connected to the cellular network 20, or be connected to it via some other network. The network does of course not have to be a cellular network but can be some type of network, such as Internet, a corporate intranet, a LAN or a wireless LAN. It can also be a so-called PSTN (Public Switched Telephone Network). The connection between the cellular phone and the server 22 will be described in more detail later.

FIG. 3 shows part of the interior of the cellular phone that are relevant for the present invention. The phone 10 includes a messaging unit 24 connected to a PIM (Personal Information Management) unit 26. The phone naturally includes other things like radio circuits, which are used for sending messages, but the PIM unit 26 and the messaging unit 24 are the parts most relevant to the present invention. The phone also has a first electronic determination unit in the form of a system clock 27, which can be set to indicate the current date in addition to the time of the day.

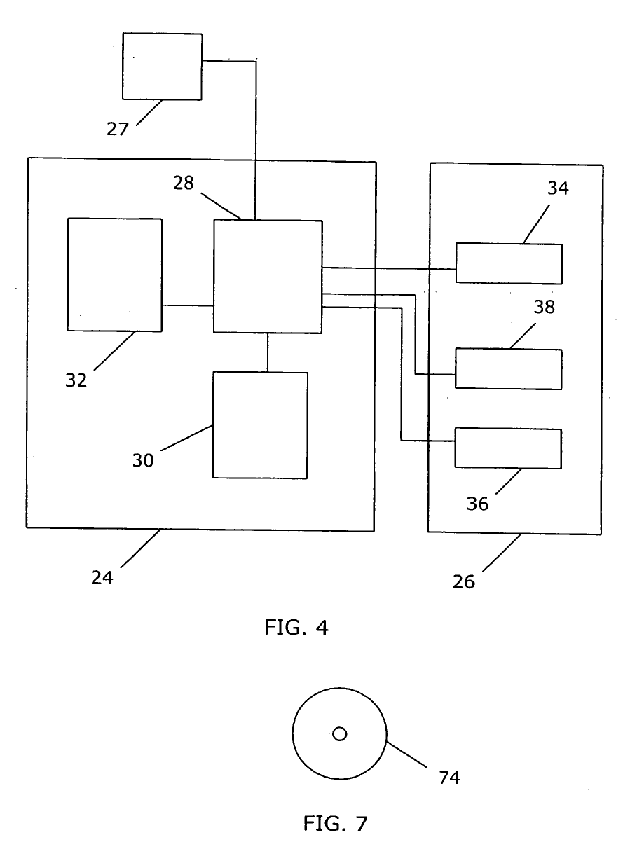

FIG. 4 shows yet a block schematic of different parts of the messaging unit 24 and the PIM unit 26 as well as the system clock 27. The messaging unit 24 includes a control unit 28, which is connected to a message transfer unit 32 and to a pre-configured message store or memory 30 including specialised messages. The control unit 28 is furthermore connected to the system clock 27. The PIM unit includes a second electronic date determination unit or a calendar 34, a first electronic contact register or contacts unit 38 and a second electronic contacts unit or a vCard unit 36. The calendar 34, contacts unit 38 and vCard unit 36 in the PIM unit 26 are connected to the control unit 28. There can of course be more different units existing in the PIM unit 26 and the messaging unit 24, but these are the units relevant for the present invention. The calendar 34 is an electronic calendar, which shows current date together with other dates both in the future as well as backwards in time. The contacts section includes by the user previously stored information about persons that can be called up or which messages can be sent to. This register is normally used for setting up a connection with contacts, like making a phone call. Typical contact information besides different types of phone numbers are title, business address, home address as well as possible extra information such as birthday and anniversary of the contact in question. The vCard unit 36 includes much of the same information as the contacts section in the form of a number of vCards. However a vCard has a special format which is possible to send to others as well as it is possible to receive from others. The vCard information is thus sometimes transferred to the contacts unit.

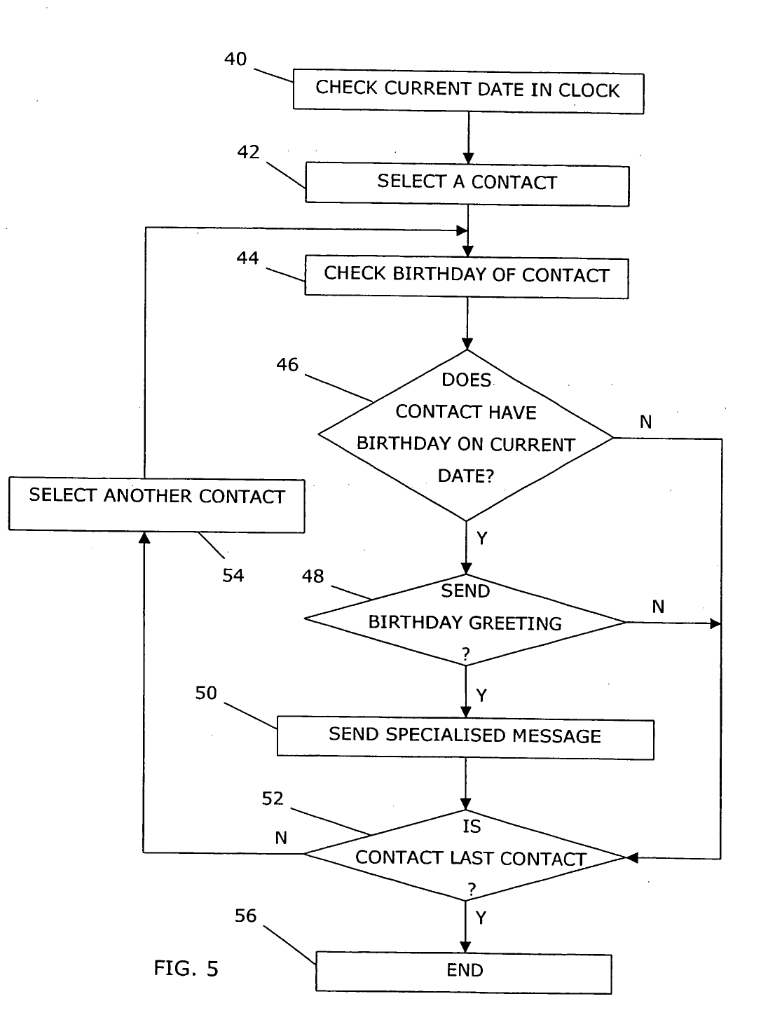

The functioning of the present invention will now be described in relation to the previously described FIG. 4 together with FIG. 5, which shows a flow chart of a preferred embodiment of a method according to the invention.

The method starts with the control unit 28 retrieving date Information by checking the date in the system clock 27, step 40. The control unit then continues by selecting a first contact, step 42. This is in the preferred embodiment done by selecting a vCard from the vCard unit 36. I should however be realised that the contact might just as well have been selected from the contacts unit 38. Thereafter the control unit 28 checks the birth date of the contact, step 44. This can also be seen as retrieving first recipient related information from the vCard unit 36. If the contact does not have a birthday on the date in the clock, step 46, then the method skips a number of steps and jumps to step 52 (to be described. later). If the contact has birthday on the date of the clock, step 46, then the user of the phone is prompted via the display if he wants to send a birthday greeting or not, step 48. If the user does not want to send a greeting, step 48, the method jumps to step 52. If however the user wants to send a birthday greeting, step 48, the control unit fetches a pre-configured birthday message from the memory 30 and enters the name of contact or recipient from the vCard into the message. It then transfers the message to the transfer unit 32, from where the specialised message is sent to a terminal of the recipient, step 50. This can be seen as the control unit 28 effectuating the automatic sending of a special pre-configured electronic message in dependence of the date information and the first recipient related information. The control unit 28 then checks if this was the last contact checked, step 52, and if it was the method is ended, step 56. If It was not the last contact the control unit continues and selects another contact, step 54. The previously mentioned steps 44-52 are then repeated as long as there are contacts left which have not been checked.

The specialised message sent is preferably an MMS message, which might show a moving and/or still picture and/or play a sound. It should also be realised that it is possible to include more than one object of the same type in the same MMS message. As is known within the art an MMS message contains a header and a form field followed by a body. The body contains different objects like text objects and picture objects as well as a SMIL object, which keeps track of when and how the other objects are to be played or displayed. The MMS message is normally sent via a GPRS connection.

There are some possible variations, which are apparent here. First of all the user might not be prompted about birthday greetings, but these can be sent fully automatically. Secondly the date can be checked in the calendar instead of in the clock. The method could also go through all contacts before prompting the user about sending messages or not. Alternatively the message could be sent beforehand, like a day or a few days before the actual birthday. The method can also be applied to anniversaries or any date of importance entered for a contact. There can also be a special message flag or a special MMS-flag set in the vCards of the vCard unit indicating only those contacts for which a birthday greeting is to be sent so that birthday greetings are only sent to those contacts for which the MMS-flag is set and that have a birthday noted in the vcard unit. This can be seen as the control unit retrieving second recipient related information from the electronic contact register.

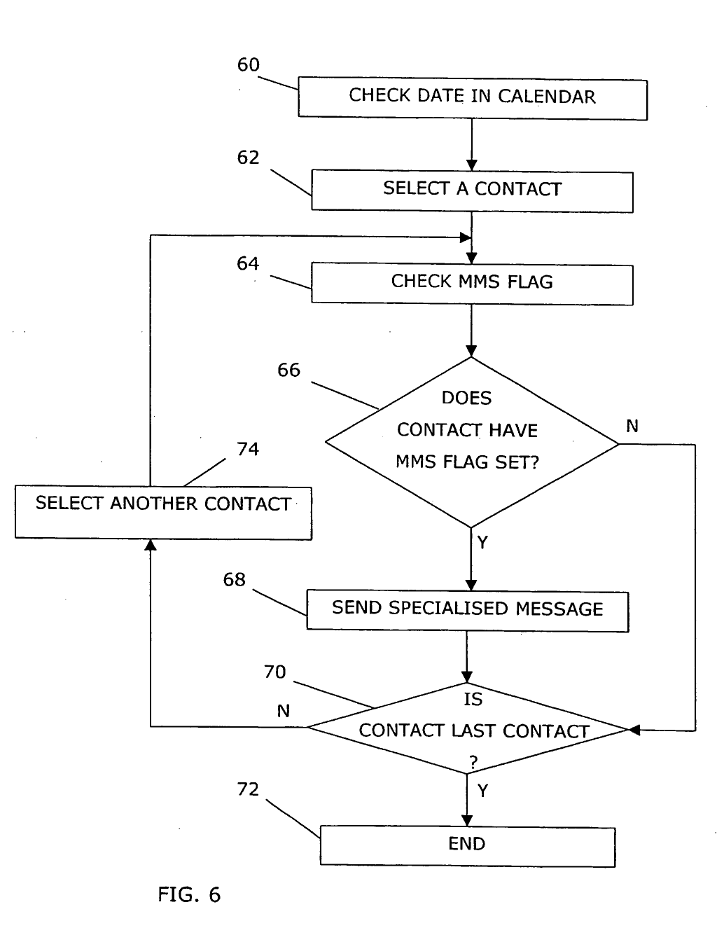

An alternative embodiment will now be described in relation to FIG. 6, which shows a second flowchart of an alternative method according to the invention. Here first the control unit checks the date in the calendar, step 60. It then checks for special holiday dates like Christmas, Easter or the like. The control unit then selects a contact from the vCard unit 36, step 62. For this contact it checks if a special MMS flag is set by the user, step 64. This flag indicates if the contact is one that shall receive a greeting or not. If the contact does not have a MMS flag set, step 66, the method jumps to step 70. If however the contact has a MMS flag set, step 66, a specialised message is fetched from the memory 30 and sent to the contact or recipient via the transfer unit 32, step 68. Also here the name is entered into the message by the control unit 28. Then the method goes on to check if the contact was the last contact, step 70. If he/she was not, another contact is selected, step 74 and steps 64-70 are repeated. If he/she was the last contact the method is ended, step 72.

Also here messages can be sent a few days In advance, the user can also get to accept or reject sending of a message. The sending of messages can also be performed after all contacts have been searched.

MMS messages are normally sent to a server, which then pushes the message to the terminal of the recipient. It is possible though that messages can be sent directly from terminal to terminal though in the future.

According to one embodiment of the invention the vCard information can be received from a server, which administers a so-called wireless village or IC Q where different people can chat with each other. Here the server keeps a contact list for the user, from which the vCard information about one or more contacts or possible recipients can be downloaded into the phone of the user. The phone can then also send specialised messages to the persons associated with the downloaded vcard information.

The device according to the present invention is preferably provided in the form of one or more processors with corresponding memory containing the program code and with memories containing the contact information and specialised messages. The transfer unit is provided in the form of standard radio circuits and uses standard protocols.

The program code mentioned above can also be provided on a data carrier such as a CD ROM disc 74 as depicted in FIG. 7, which will perform the invention when loaded into a computer or into a phone having suitable processing capabilities. The program code can also be downloaded remotely from a server either outside or inside the cellular network or be downloaded via a computer like a PC to which the phone is temporarily connected.

The messages mentioned before are pre-configured. They are thus normally provided by a message provider, like for instance the operator of the network. It is also possible that the user can design his own special messages.

The present invention has several advantages. With the present Invention a user can easily send special greetings to people he wants to send in a fast, simple and automatic way. He does not have to browse large amounts of information about all his contacts and look for important events in order to send a special message. The invention makes it possible to filter out important information in the PIM and lets the user make people happy by remembering their birthdays and other important dates in a simple fashion.

The messages sent are preferably MMS messages. The invention is however not limited to these types of messages. It is equally as well applicable for any type of electronic messages such as SMS messages or e-mail messages.

1. A method of automatically sending electronic messages from a portable communication device to a selected recipient, comprising
retrieving date information from an electronic date determination unit;
retrieving first recipient related information from an electronic contact register; and
automatically sending a pre-configured electronic message over a network to the recipient based on the date information and the first recipient related information.

2. The method according to claim 1, wherein the first recipient related information is date information associated with the recipient.

3. The method according to claim 1, wherein the first recipient related information is a message flag.

4. The method according to claim 1, further comprising:
retrieving second recipient related information from the electronic contact register; and
automatically sending the pre-configured electronic message over the network to the recipient based on the date information, first recipient related information and the second recipient related information.

5. The method according to claim 4, wherein the second recipient related information is a message flag.

6. The method according to claim 1, further comprising:
prompting a user, after retrieving date and recipient related information, about sending the message; and
sending the message if the user has accepted sending.

7. The method according to claim 1, further comprising:
retrieving a name of the recipient from the contact register; and
inserting the name into the message prior to sending.

8. The method according to claim 1, wherein the message is sent directly to a terminal of the recipient.

9. The method according to claim 1, wherein the message is sent to a remote server, which pushes it to a terminal of the recipient.

10. The method according to claim 1, wherein contact information about a recipient is first received from a remote server and then placed in the contact register.

11. The method according to claim 1, wherein the contact register is a register containing previously stored information about contacts and how these can be reached.

12. A portable communication device for automatically sending electronic messages to a selected recipient comprising:
an electronic date determination unit;
an electronic contact register;
a message transfer unit;
a pre-configured message store; and
a control unit configured to retrieve date information from the electronic data determination unit and first recipient related information relating to a recipient from the electronic contact register and effectuate automatic sending of a pre-configured electronic message to the recipient based on the date information and the first recipient related information.

13. A portable communication device according to claim 12, wherein the first recipient related information is date information associated with the recipient.

14. A portable communication device according to claim 12, wherein the first recipient related information is a message flag.

15. A portable communication device according to claim 12, wherein the control unit is further configured to retrieve second recipient related information from the electronic contact register and effectuate sending of the message based on the second recipient related information.

16. A portable communication device according to claim 15, wherein the second recipient related information is a message flag.

17. A portable communication device according to claim 12, wherein the control unit after retrieving date and recipient related information is further configured to prompt a user about sending the message and effectuate sending of the message if the user has accepted sending.

18. A portable communication device according to claim 12, wherein the control unit is further configured to retrieve the name of the recipient from the contact register and to insert the name into the message prior to sending.

19. A portable communication device according to claim 12, wherein the control unit effectuates sending of the message directly to a terminal of the recipient.

20. A portable communication device according to claim 12, wherein the control unit effectuates sending of the message to a remote server, which pushes it to the recipient.

21. A portable communication device according to claim 12, wherein the message transfer unit receives contact information about a recipient from a remote server and the control unit is further configured to place this information in the contact register.

22. A portable communication device according to claim 12, wherein the device is a cellular phone.

23. A portable communication device according to claim 12, wherein the contact register is a register containing previously stored information about contacts and how these can be reached.

24. A computer program product stored on a computer readable medium comprising:
computer readable program code configured to retrieve date information from an electronic date determination unit;
computer readable program code configured to retrieve recipient related information from an electronic contact register; and
computer readable program code configured to effectuate automatic sending of a pre-configured electronic message over a network to the recipient based on the date information and the recipient related information.

25. (canceled)
